(19) United States
(12) Patent Application Publication
(10) Pub. No.: US 2003/0067997 A1
(43) Pub. Date: Apr. 10, 2003

(54) Intermediate frequency signal amplitude equalizer for multichannel applications

(76) Inventors: Mark Kintis, Manhattan Beach, CA (US); James B. Wade, Redondo Beach, CA (US); Mark V. Keller, Palos Verdes Estates, CA (US)

Correspondence Address: PATENT COUNSEL, TRW INC., S & E LAW DEPT., ONE SPACE PARK, BLDG. E2/6051, REDONDO BEACH, CA, 90278, US

(21) Appl. No.: 09/971,715

(22) Filed: Oct. 4, 2001

(51) Int. Cl. H04L 27/22

(52) U.S. Cl. 375/329

(57) ABSTRACT

A multichannel signal amplitude equalizer (102) includes a multichannel signal input (112) that carries an input signal with an input bandwidth spanning multiple communication channels. The equalizer also includes a multichannel equalizer (114) connected to the multichannel signal input (112) and that includes a signal output (116). The multichannel equalizer (114) connects to an equalizer control input (130) for regulating the multichannel equalizer (114) to attenuate selected frequency bands in the input signal. As a result, the signal output (116) carries, as an output signal, the input signal reduced in dynamic range. The equalizer (102) generally includes an analog to digital (A/D) converter (122) coupled to the multichannel equalizer (114) for digitizing the output signal. The A/D converter (122) is characterized by an A/D converter dynamic range that is at least equal to the output signal dynamic range and a bandwidth at least equal to the input bandwidth.

### BACKGROUND OF THE INVENTION

The preferred embodiments of the present invention generally relates to an equalization system in a RF communications system. More particularly, the preferred embodiments of the present invention relate to a multichannel signal amplitude equalization system.

Many types of wireless communication services have emerged in a relatively short period of time. Service subscribers, in turn, have quickly discovered the significant benefits in convenience and accessibility stemming from wireless communication. As a result, wireless communications services have advanced quickly into a position of popularity and profitability.

Generally, a wireless communication transmitter transmits information to a subscriber in a “channel”. A channel represents a portion of electromagnetic spectrum having a predetermined bandwidth in which signal information resides. As one example, the European Global System Mobile (GSM) defines 200 KHz wide channels with 200 KHz spacing starting at 880 MHz.

In certain wireless applications, a single receiver processes multiple individual channels in order to recover the signal information present in each channel. In the past, such receivers included a separate processing chain for each channel. The processing chain generally included, for example, a local IF oscillator (for converting a transmitted frequency to a first working frequency), a bandpass filter (for isolating a channel), a second IF oscillator (for downconverting the isolated channel for further processing), and an Analog to Digital converter (for digitizing the downconverted isolated channel).

By processing channels individually, the receiver relaxed certain design requirements for the processing chain. For example, off the shelf low bandwidth A/D converters with 60 dB dynamic range were capable of digitizing the relatively narrow bandwidth downconverted isolated channel. However, a receiver that included multiple processing chains incurred significant cost increases arising from the duplication of processing chain components for each channel.

As a result, designers proposed an alternative receiver implementation that used a single bulk processing chain to recover signal information from multiple channels. The bulk processing chain included an IF local oscillator (for converting a transmitted frequency to a first working frequency), a bandpass filter (for isolating multiple channels in a wide slice of bandwidth), a second IF local oscillator (for further downconverting the wide slice of bandwidth for additional processing), and a single A/D converter (for digitizing the slice of spectrum spanning the multiple channels). The bulk processing chain further included a channelizer following the A/D converter for separating out individual channels after digitization.

However, an A/D converter capable of digitizing a wide slice of bandwidth must meet the dynamic range requirements of that wide slice of bandwidth. Thus, digitizing a slice of bandwidth spanning more than 10-20 channels required that the bulk processing chain include an A/D converter with extremely large dynamic range (e.g., 90 dB or more). Such A/D converters are not presently available.

A need has long existed in the industry for a signal amplitude equalizer that addresses the problems noted above and others previously experienced.

### BRIEF SUMMARY OF THE INVENTION

A preferred embodiment of the invention provides a multichannel signal amplitude equalizer front end. The front end includes a multichannel signal input that carries an input signal with an input bandwidth spanning multiple communication channels. The front end also includes a multichannel equalizer connected to the multichannel signal input and that provides a signal output. The multichannel equalizer connects to an equalizer control input for regulating the multichannel equalizer to attenuate selected frequency bands in the input signal. As a result, the signal output carries an output signal that is the input signal reduced in dynamic range.

The equalizer generally includes an analog to digital (A/D) converter coupled to the multichannel equalizer for digitizing the output signal. The A/D converter is characterized by an A/D converter dynamic range (e.g., 60 dB or less) that is at least equal to the output signal dynamic range. Furthermore, the A/D converter is characterized by an A/D converter bandwidth at least equal to the input bandwidth.

The multichannel equalizer may be constructed using, as examples, transversal filters and variable phase and amplitude modules. The input bandwidth, as examples, may span 3 to 80 communication channels (or more). Thus, the input signal may encompass many Global System Mobile (GSM) or North American Interim Standard (IS) (e.g., IS-54 or IS-136) communication channels, for example.

In obtaining the input signal, the front end may include a first local oscillator for downconverting a transmitted signal (as received) as well as a first bandpass filter spanning the input bandwidth and coupled to the first local oscillator. In preparation for digitizing the output signal, the front end may optionally include a second local oscillator coupled to the signal output for downconverting the output signal, and a second bandpass filter spanning the input bandwidth and coupled to the first analog to digital converter.

The present invention may also be implemented as a method for equalizing signal amplitude in an input signal. The method includes obtaining an input signal with an input bandwidth spanning multiple communication channels, coupling the input signal through a multichannel equalizer, and reducing input signal dynamic range using the multichannel equalizer. An output signal on a signal output of the multichannel equalizer is thereby generated with dynamic range appropriate for A/D conversion.

### BRIEF DESCRIPTION OF THE DRAWINGS

FIG. 1 illustrates a multichannel receiver.

FIG. 2 shows a transversal filter.

FIG. 3 shows a variable amplitude and phase module.

FIG. 4 depicts a flow diagram for equalizing signal amplitude in an input signal.

### DETAILED DESCRIPTION OF THE INVENTION

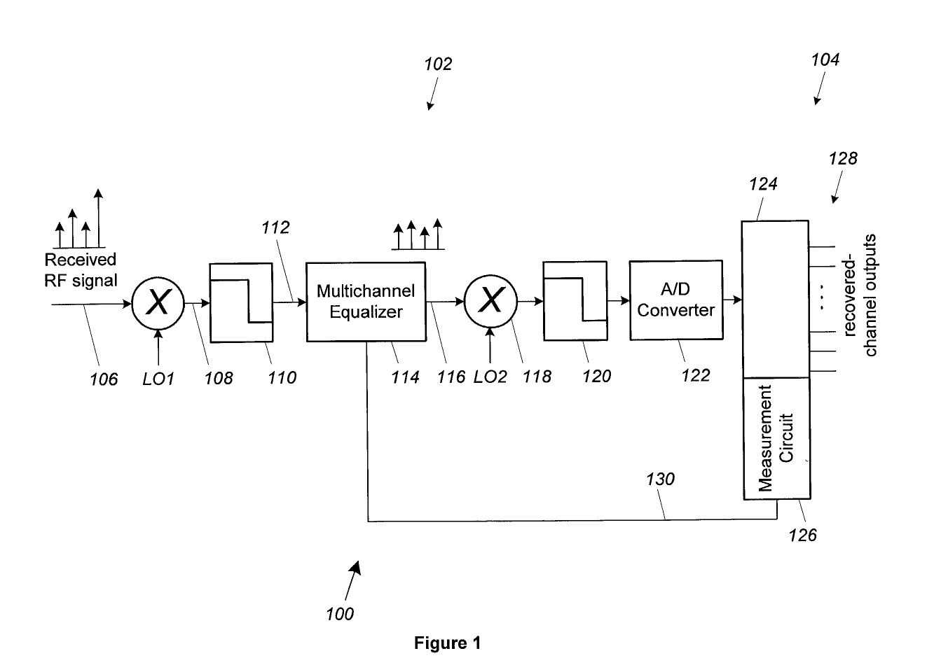

With reference first to FIG. 1, a multichannel receiver 100 includes a multichannel signal amplitude equalizer front end 102 and a back end 104. The front end 102 includes a received signal input 106, a first local oscillator 108, and a first bandpass filter 110. The front end 102 also includes a signal input 112, a multichannel equalizer 114, a signal output 116, a second local oscillator 118, and a second bandpass filter 120. In addition, an analog to digital (A/D) converter 122 couples to the second bandpass filter 120. The back end 104 includes a channelizer 124, a measurement circuit 126, and recovered-channel outputs 128.

The received signal input 106 carries a received signal obtained, for example, from a reception antenna (not shown). The received signal generally has a very large bandwidth at very high frequencies (e.g., in the 900 MHz or 1.8 GHz frequency space). Thus, the first local oscillator 108 provides a first downconversion to a first intermediate frequency (IF), while the first bandpass filter 110 severely attenuates frequency components outside of a preselected input bandwidth to provide the input signal for the multichannel equalizer 114.

As an example, the input signal may be centered at 189 MHz with a input bandwidth of 15 MHz. Other center frequencies and input bandwidth are also suitable, however. The input bandwidth determines the number of communication channels that the input signal spans or includes.

An input bandwidth of 15 MHz, for example, encompasses 75 Global System Mobile (GSM) channels. Each GSM channel is 200 KHz wide with 200 KHz spacing between channels. In certain GSM implementations, only every third frequency is used, and therefore 15 MHz spans 25 active channels. It is noted that in North America, the input bandwidth may be selected to span a reselected number of Interim Standard 54 or 136 (i.e., IS-54 or IS-136) communication channels instead. The invention is not limited to IS or GSM communication channels, however, or to any particular input bandwidth.

The multichannel equalizer 114, discussed in more detail below, provides circuitry that selectively attenuates individual channels in the input signal. Thus, for example, communication channels that are excessively strong may be attenuated so that the output signal is a modified version of the input signal with dynamic range below a predetermined threshold (e.g., 60 dB or less) across the input bandwidth.

Optionally, the front end 102 includes the second local oscillator 118 and second bandpass filter 120. The second local oscillator 118 and second bandpass filter 120 provide downconversion of the output signal to a second IF (e.g., 16.3 MHz) suitable for subsequent processing (and, in particular, A/D conversion).

To that end, the A/D converter 122 digitizes the output signal and provides output signal samples to the channelizer 124. The dynamic range threshold noted above is generally no greater than the dynamic range capability of the A/D converter 122. Similarly, the input bandwidth is generally no greater than the input bandwidth capability of the A/D converter 122.

Note that due to the controlled reduction in dynamic range of the input signal, the A/D converter 122 may digitize the resultant output signal. As a result, the A/D converter 122 digitizes, in bulk, all the communication channels present in the output signal. The channelizer 124 then separates out individual channels and provides the individual channels as signal samples on the recovered-channel outputs 128. The channelizer 124 may be of conventional design, or may be a Discrete Fourier Transform channelizer such as that described in TRW Docket No. 12-1222, filed concurrently herewith, titled “Cellular Communications Channelizer”, and incorporated herein by reference in its entirety.

The measurement circuit 126 regulates the multichannel equalizer 114 using the equalizer control input 130. The measurement circuit 126 may be implemented as a general purpose signal processor, dedicated arithmetic circuitry, and the like, and may be integral with, or separate from, the channelizer 124. The equalizer control input 130 may comprise one or more data, address, or control lines, for example, that adjust attenuation of individual communication channels in the input signal using the multichannel equalizer 114.

Preferably, the measurement circuit 126 measures output levels of recovered-channel signals. For example, the measurement circuit 126 may determine the average power level of recovered-channel signals. Thus, when a particular average power level in a communication channel is above a predetermined threshold, the measurement circuit 126 asserts attenuation control signals on the equalizer control input 130 to attenuate the frequency band containing that communication channel. Similarly, if multiple communication channels exceed in average power the predetermined threshold, then the measurement circuit 126 may assert attenuation control signals on the equalizer input 130 to attenuate multiple frequency bands in the input signal. As a result, the measurement circuit 126 directs the multichannel equalizer 114 to reduce the dynamic range of the input signal to within a predetermined threshold.

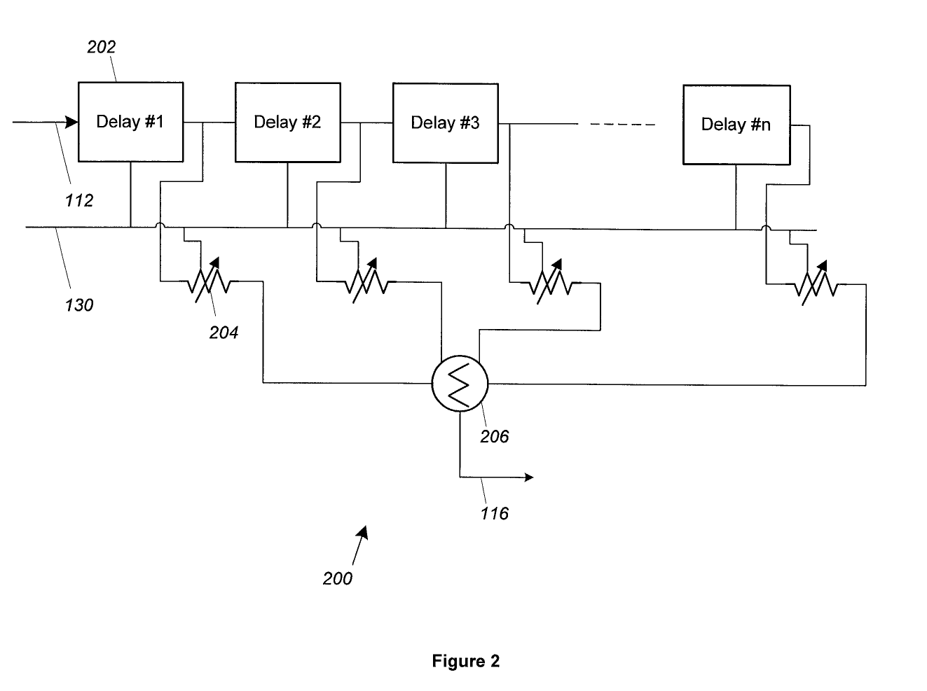

The multichannel equalizer 114 incorporates one or more communication channel attenuators that attenuate frequency bands in the input signal. Turning to FIG. 2, for example, that figure shows a channel attenuator 200 constructed from a transversal filter.

The channel attenuator 200 includes series connected delay elements (e.g., the delay element 202). The outputs of one or more of the delay elements are individually connected to variable amplitude devices (e.g., the variable amplitude device 204). The summer 206 adds the amplitude modified outputs together to form the output signal present on the signal output 116.

The delay elements may be constructed from switched delay lines or variably loaded transmission lines and the variable amplitude devices may be constructed from switchable attenuators, P/N diode attenuators or variable gain amplifiers, as examples. Furthermore, the component values used to implement the delay elements and the variable amplitude devices may be selected according to established transversal filter design methodologies and computer modeling techniques.

As noted above, the equalizer control input 130 carries attenuation control signals to the channel attenuator 200. Thus, for example, the attenuation control signals may switch in or switch out components that modify resistances, capacitances, inductances, and other circuit parameters to configure the channel attenuator 200 to attenuate one or more communication channels in the input signal. To that end, and as an additional example, the attenuation control signals may activate or deactivate delay elements, variable amplitude devices, and the like to provide further reconfiguration options.

In accordance with the established transversal filter design techniques, the channel attenuator 200 may be designed to provide variable attenuation in one or more communication channels. Thus, for example, the channel attenuator 200 may switchably provide either 0 dB or 6 dB attenuation across one or more entire communication channel. Alternatively, the channel attenuator 200 may provide attenuation in steps. For example, the channel attenuator may switchably provide either 0 dB, 3 dB, 6 dB, 9 dB, or 12 dB of attenuation substantially across one or more communication channels.

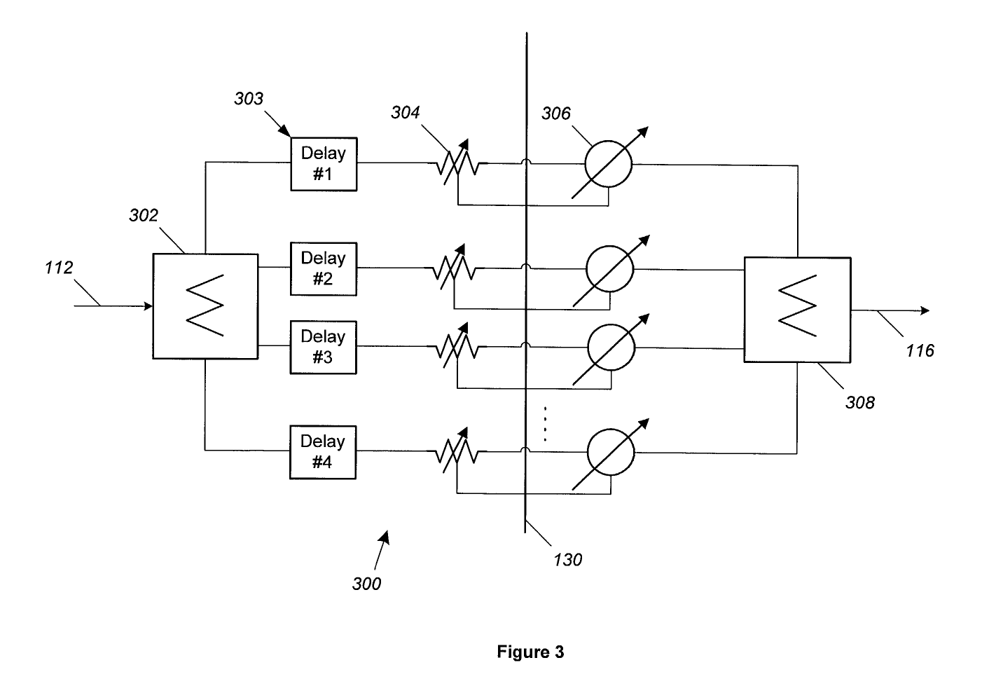

Turning next to FIG. 3, a second example of a channel attenuator 300 is shown. The channel attenuator 300 constructed from a variable phase and amplitude module. The channel attenuator 300 includes an input signal splitter 302, individual delay elements 303, individual variable amplitude devices 304, individual variable phase devices 306, and a signal summer 308 to construct the output signal.

The variable phase devices 306 may be constructed from I/Q vector modulators and the variable amplitude devices 304 may be constructed from P/N diode attenuators, as examples. As with the transversal filter noted above, the component values used to implement the variable phase devices 306 and the variable amplitude devices 304 may be selected according to established transversal filter design methodologies and computer modeling techniques.

The equalizer control input 130 carries attenuation control signals to the channel attenuator 300. Thus, the attenuation control signals configure the variable phase devices 306 and the variable amplitude devices 304 to provide selected attenuation in one or more communication channels in the input signal.

In one embodiment, a single channel attenuator 200 or channel attenuator 300 operates over the entire input bandwidth of the input signal. However, multiple channel attenuators may also be provided in parallel, with each channel attenuator covering a predetermined portion of the input bandwidth.

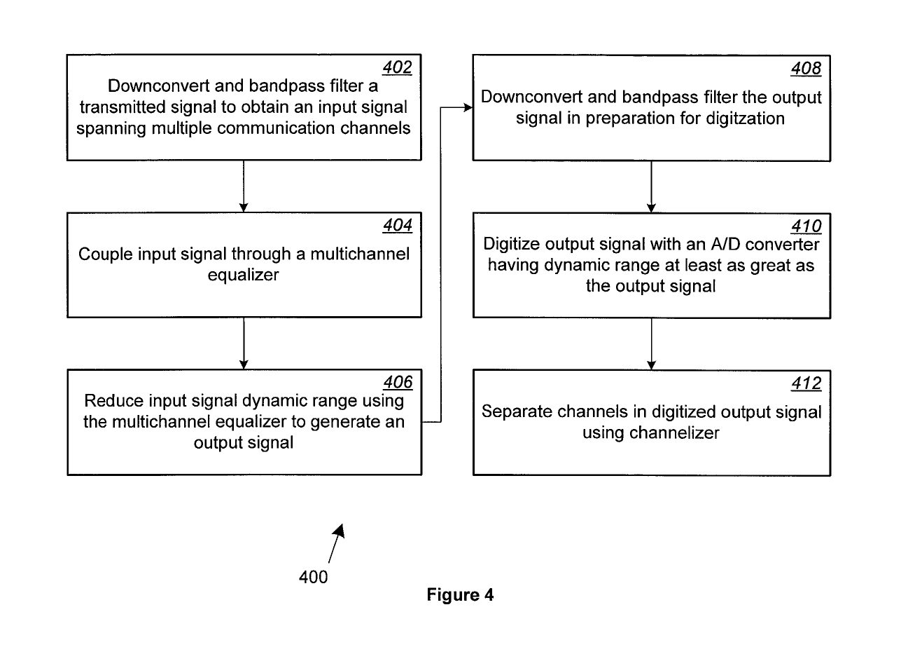

Turning next to FIG. 4, that figure presents a flow diagram 400 for equalizing signal amplitude in an input signal. The flow diagram 400 summarizes the operation of the multichannel receiver 100 discussed above. First, the multichannel receiver 100 downconverts and bandpass filters (402) a transmitted signal to obtain an input signal with input bandwidth spanning multiple communication channels.

The multichannel receiver 100 then couples (404) the input signal through the multichannel equalizer 114. The measurement circuit 126 reduces (406) the dynamic range of the input signal using the multichannel equalizer 114, thereby producing an output signal. The output signal may optionally be further downconverted and bandpass filtered (408) in preparation for digitization. Subsequently, the A/D converter 122 digitizes (410) the output signal (and therefore all of the communication channels in the input signal). The channelizer 124 may then separate (412) individual channels from the digitized output signal and provide the individual channels on the recovered-channel outputs 128.

Thus, the invention provides a multichannel receiver that recovers communication channels in bulk from a received signal. The structure of the multichannel receiver includes a multichannel equalizer that reduces dynamic range of an input signal commensurate with a dynamic range capability of an A/D converter. The resultant receiver thus avoids the expense and complication stemming from duplication of individual channel processing chains.

While the invention has been described with reference to one or more preferred embodiments, those skilled in the art will understand that changes may be made and equivalents may be substituted without departing from the scope of the invention. In addition, many modifications may be made to adapt a particular step, structure, or material to the teachings of the invention without departing from its scope. Therefore, it is intended that the invention not be limited to the particular embodiment disclosed, but that the invention will include all embodiments falling within the scope of the appended claims.

What is claimed is:

1. A multichannel signal amplitude equalizer comprising:
a multichannel signal input for carrying an input signal with an input bandwidth spanning multiple communication channels;
a multichannel equalizer connected to the multichannel signal input and including a signal output; and
an equalizer control input coupled to the multichannel equalizer for regulating the multichannel equalizer, whereby the signal output carries, as an output signal, the input signal reduced in dynamic range.

2. The multichannel signal amplitude equalizer of claim 1, further comprising an analog to digital (A/D) converter coupled to the multichannel equalizer for digitizing the output signal, wherein the A/D converter is characterized by an A/D converter dynamic range at least equal to an output signal dynamic range.

3. The multichannel signal amplitude equalizer of claim 2, wherein the A/D converter is characterized by an A/D converter bandwidth at least equal to the input bandwidth.

4. The multichannel signal amplitude equalizer of claim 1, wherein the multichannel equalizer comprises at least one transversal filter.

5. The multichannel signal amplitude equalizer of claim 1, wherein the multichannel equalizer comprises at least one variable amplitude and phase module.

6. The multichannel signal amplitude equalizer of claim 1, wherein the wherein the multichannel equalizer comprises at least first and second channel attenuators.

7. The multichannel signal amplitude equalizer of claim 1, wherein each channel of the multiple communication channels is a Global System Mobile (GSM) channel.

8. The multichannel signal amplitude equalizer of claim 1, wherein each channel of the multiple communication channels is a North American Interim Standard (IS) channel.

9. The multichannel signal amplitude equalizer of claim 1, further comprising a first local oscillator for downconverting a received signal, and a first bandpass filter spanning the input bandwidth and coupled to the first local oscillator and the multichannel signal input.

10. The multichannel signal amplitude equalizer of claim 1, further comprising a second local oscillator coupled to the signal output for downconverting the output signal, and a second bandpass filter spanning the input bandwidth and coupled to the first analog to digital converter.

11. The multichannel signal amplitude equalizer of claim 1, wherein the input signal is a radio frequency input signal.

12. A method for equalizing signal amplitude in an input signal, the method comprising:
obtaining an input signal with an input bandwidth spanning multiple communication channels;
coupling the input signal through a multichannel equalizer; and
reducing input signal dynamic range using the multichannel equalizer, thereby generating an output signal on a signal output of the multichannel equalizer.

13. A method according to claim 12, wherein reducing further comprises reducing input signal dynamic range to be no greater than a predetermined dynamic range.

14. A method according to claim 13, further comprising digitizing the output signal with an analog to digital (A/D) converter, and wherein reducing further comprises reducing input signal dynamic range to be no greater than a predetermined dynamic range of the A/D converter.

15. A method according to claim 13, wherein obtaining comprises obtaining a radio frequency input signal.

16. A method according to claim 12, wherein obtaining comprises obtaining a radio frequency input signal with an input bandwidth spanning multiple wireless communication channels.

17. A method according to claim 16, wherein obtaining comprises obtaining at least one of a radio frequency input signal with an input bandwidth spanning at least one of multiple Global System Mobile (GSM) communication channels and multiple North American Interim Standard (IS) communication channels.

18. A method according to claim 12, further comprising producing the input signal by first downconverting and first bandpass filtering a received signal.

19. A method according to claim 18, further comprising preparing the output signal for digitization by second downconverting and second bandpass filtering the output signal.

20. A multichannel receiver comprising:
a multichannel signal input for carrying an input signal with an input bandwidth spanning multiple communication channels;
a multichannel equalizer connected to the multichannel signal input and including a signal output;
an equalizer control input coupled to the multichannel equalizer for regulating the multichannel equalizer, whereby the signal output carries, as an output signal, the input signal reduced in dynamic range; and
a channelizer coupled to the analog to digital converting and comprising a plurality of recovered-channel outputs.

21. The multichannel receiver of claim 20, further comprising a measurement circuit coupled to the recovered-channel outputs for measuring an output level of a recovered-channel signal.

22. The multichannel receiver of claim 21, wherein the measurement circuit is coupled to the equalizer control input.

23. The multichannel receiver of claim 21, wherein the output level is average power in the recovered-channel signal.

24. The multichannel receiver of claim 22, wherein the measurement circuit is adapted to output an attenuator regulation signal on the equalizer control input when the output level exceeds a predetermined threshold.

25. The multichannel receiver of claim 20, wherein the multichannel equalizer comprises at least one of a transversal filter and a variable phase and amplitude module.

26. The multichannel receiver of claim 20, wherein the multichannel equalizer comprises a multistep attenuator in at least one channel.
